(19) United States
(12) Patent Application Publication
(10) Pub. No.: US 2020/0365363 A1
(43) Pub. Date: Nov. 19, 2020

(54) PORTABLE X-RAY TUBE

(71) Applicant: XL CO., LTD., Wonju-si, Gangwon-do (KR)

(72) Inventor: Rae Jun PARK, Wonju-si, Gangwon-do (KR)

(73) Assignee: XL CO., LTD., Wonju-si, Gangwon-do (KR)

(21) Appl. No.: 16/636,568

(22) PCT Filed: Aug. 4, 2017
(86) PCT No.: PCT/KR2017/008432

§ 371 Date: Feb. 4, 2020

(51) Int. Cl. H01J 35/18; H05G 1/06; H01J 35/14; H01J 35/06

(52) U.S. Cl. CPC H01J 35/18; H01J 35/064; H01J 35/14; H05G 1/06

(57) ABSTRACT

The present invention relates to a portable X-ray tube, and more particularly, to a portable X-ray tube capable of miniaturization and weight reduction by reducing the structural volume of the X-ray tube by installing cathodes in the same direction together with the fixed anode. The portable X-ray tube comprises: an anode portion comprising an anode heat sink for conducting and dissipating heat transferred through the anode, an anode formed on the upper part of the anode heat sink, and an anode target formed on the inclined surface of the upper end of the anode; a cathode portion installed in parallel with the anode through the installation hole of the cathode portion formed in the anode heat sink; and a vacuum bulb fixed to the heat sink to seal the anode portion and the cathode portion with a vacuum; wherein the X-rays emitted through the anode target are irradiated to the upward direction as the installation direction of the anode.

### TECHNICAL FIELD

The present invention relates to a portable X-ray tube and more particularly, to a portable X-ray tube capable of miniaturization and light weight by reducing the structural volume of the X-ray tube by installing the cathodes in the same direction together with the fixed anode.

### BACKGROUND ART

X-ray tubes, which are most commonly used in medical imaging, are obtained by emitting hot electrons from high temperature heated filaments and colliding them with the surface of target metal. These X-rays provide a variety of information about human tissue to patients and doctors. However, because X-rays are harmful to humans due to exposure, it is important to obtain high resolution medical images through minimal radiation exposure. In order to improve the duality of X-rays, studies have been actively conducted on filters, generators, detectors, and image processing algorithms.

However, the most fundamental determinant of X-ray image quality is the focal spot size formed when the hot electron beam strikes the target metal. The smaller the focal size and the higher the density, high resolution images with little penumbra can be achieved. Focal size is influenced by various specifications of X-ray tubes, and this study has been carried out since the early 90 s. In 1937, N.C. Beese studied the focal size according to the filament shape and position. In 1974, E. L. Chaney studied the focus according to tube current and tube voltage. In 2004, Siemens developed a technique to control focus position to use two magnets in CT X-ray tube.

In the 2000 s, according to the development of computer processing speed and the development of simulation techniques such as finite element analysis (FEA) and Monte Carlo method, the research on the focus to use these simulation technique has been conducted. The simulation program can predict the path and shape of the invisible electron beam, and can effectively predict the results for various variables of the X-ray tube. Using FEA, in 2014, GE Global Research studied the change of focus according to tube voltage and tube current, and in 2015, T. D. LEE studied the focus characteristics of electron beams generated in carbon nanotube (CNT) X-ray tubes.

Low dose of X-ray, radiation exposure reduction and high quality image acquisition are the topics in the field of medical diagnostic imaging, and now, the research and development for the field are being actively conducted by many companies. Due to the development of information and communication technology, convergence has been improved in various fields to improve user convenience, and in the field of medical imaging, research and development on wireless image transmission and remote device operation by ICT (Information convergent technology) technology convergence are in progress. The demand for outdoor diagnostic equipment/inspection equipment is rapidly increasing and the demand for responding to various unspecified diagnosis and inspection situations occurring outdoors such as emergency disasters, military unit demand, and on-site inspection of dangerous goods is rapidly increasing. In addition, as the quality of life increases, the demand for medical services are advanced and telemedicine and home medical care are being reviewed, it is necessary to correspond to the future market of the advanced portable X-ray tube diagnosis equipment. In order to cope with various unspecified diagnosis and inspection situations occurring outdoors, the X-ray diagnostic apparatus must be small and light for easy portability, and high power and high energy conditions must be provided.

FIG. 1 is a view of the structure of a conventional X-ray tube. As shown in the figure, the X-ray tube has the structure which the anode 11 and the cathode focusing tube 14 are disposed in opposite directions each other, and the X-rays generated when the electrons emitted from the cathode filament 13 collide with the anode target 12 are irradiated to the X-ray irradiation direction. The anode 11 and the cathode focusing tube 13 are sealed with a glass bulb 16, and the glass bulb 16 is fixedly mounted to the anode 11 by a kovar adapter 17 at the lower part of the anode. The cathode electrode stem 15 for supplying power to the cathode filament 13 is connected, and the power is supplied to the cathode electrode stem 15. In addition, the anode 11 accumulates heat generated when the electron hits the target and conducts and releases it to the outside, and the anode target 12 serves to generate X-rays while the accelerated electron collides to the target 12, the cathode filament 13 serves to emit hot electrons when heated, the cathode focusing tube 14 focuses the electron beam to form a focus, and the cathode electrode stem 15 applies power and high voltage to the filament. The glass bulb 16 is formed to maintain a vacuum, and the glass and the metal are vacuum-tightly bonded with a kovar adapter to form a vacuum inside the glass bulb 16.

As described above, since the anode and the cathode are installed in opposite directions to each other and the irradiation direction of X-rays also proceeds in a direction orthogonal to the anode and the cathode, there is a problem it is not easy to be miniaturization and light weight for X-ray tube.

### DISCLOSURE

### Technical Problem

An object of the present invention is to provide a portable X-ray tube that can structurally simplify an X-ray tube by providing an anode and a cathode in the same direction and can provide X-ray tube of small size and light weight, and can provide X-ray tube which generates X-rays of high power and high energy.

### Technical Solution

In order to achieve the above object, the present invention provides a portable X-ray tube. The portable X-ray tube comprises: an anode portion comprising an anode heat sink for conducting and dissipating heat transferred through the anode, an anode formed on the upper part of the anode heat sink, and an anode target formed on the inclined surface of the upper end of the anode; a cathode portion installed in parallel with the anode through the installation hole of the cathode portion formed in the anode heat sink; and a vacuum bulb fixed to the heat sink to seal the anode portion and the cathode portion with a vacuum; wherein the X-rays emitted through the anode target are irradiated to the upward direction as the installation direction of the anode.

The vacuum bulb is fixed by kovar adapter which one side is coupled to the outer circumferential surface of the anode heat sink made of a cylindrical shape and the other side is coupled to the vacuum bulb.

Further, the kovar adapter is formed to wrinkle outward for heat dissipation.

A vacuum exhaust hole for vacuum exhaust of the vacuum bulb is formed in the anode heat sink, and the vacuum exhaust tube is mounted in the vacuum exhaust hole to be sealed after vacuum exhaust.

The cathode portion comprising: a cathode filament facing the anode target to emit accelerated hot electrons to the anode target; a cathode focusing tube mounted in a groove formed inside the cathode filament to focus an electron beam emitted from the cathode filament; a cathode electrode stem connected to a lower portion of the cathode focusing tube; a cathode high voltage insulation bushing connected to a lower portion of the cathode electrode system; a power cable connected to a lower portion of the cathode high voltage insulation bushing; and a cathode support tube surrounding the cathode electrode system and the cathode high voltage insulation bushing.

The cathode support tube is penetrated through the installation hole of the cathode portion, and the lower end of the cathode support tube is fixed to the installation hole of the cathode portion by kovar adapter.

Further, the cathode support tube is made of glass or ceramic.

Further, the vacuum bulb is formed of glass or ceramic.

Further, a beryllium (Be) window is formed on an upper portion of the ceramic vacuum bulb.

### Advantageous Effects

The present invention has the advantage of structurally simplifying the X-ray tube by installing the anode and cathode in the same direction.

In addition, the present invention has the advantage that since the anode and the cathode are installed in the same direction, the installation of the associated assembly can be simplified to reduce the size and weight.

In addition, the present invention has the advantage that it is possible to provide high power, high energy X-rays because the heat capacity of the anode heat sink is large.

### DESCRIPTION OF DRAWINGS

FIG. 1 is a structural diagram of a conventional X-ray tube.

FIG. 2 is a structural diagram of an embodiment of an X-ray tube according to the present invention.

FIG. 3 is a perspective view of another embodiment of an X-ray tube according to the present invention;

FIG. 4 is a perspective view of the third embodiment of an X-ray tube according to the present invention;

### MODES OF THE INVENTION

A portable X-ray tube, which is the best mode for carrying out the present invention, comprises: an anode portion comprising an anode heat sink for conducting and dissipating heat transferred through the anode, an anode formed on the upper part of the anode heat sink, and an anode target formed on the inclined surface of the upper end of the anode; a cathode portion installed in parallel with the anode through the installation hole of the cathode portion formed in the anode heat sink; and a vacuum bulb fixed to the heat sink to seal the anode portion and the cathode portion with a vacuum; wherein the X-rays emitted through the anode target are irradiated to the upward direction as the installation direction of the anode.

Hereinafter, preferred embodiments of the present invention will be described in detail with reference to the accompanying drawings. However, this is to explain in detail enough to easily practice the invention having ordinary knowledge in the art to which the present invention belongs, and this does not mean that the technical spirit and scope of the present invention is limited.

First, prior to describing a preferred embodiment of the present invention, it is noted that in the various embodiments of the present invention the same reference numerals are used for the same configuration.

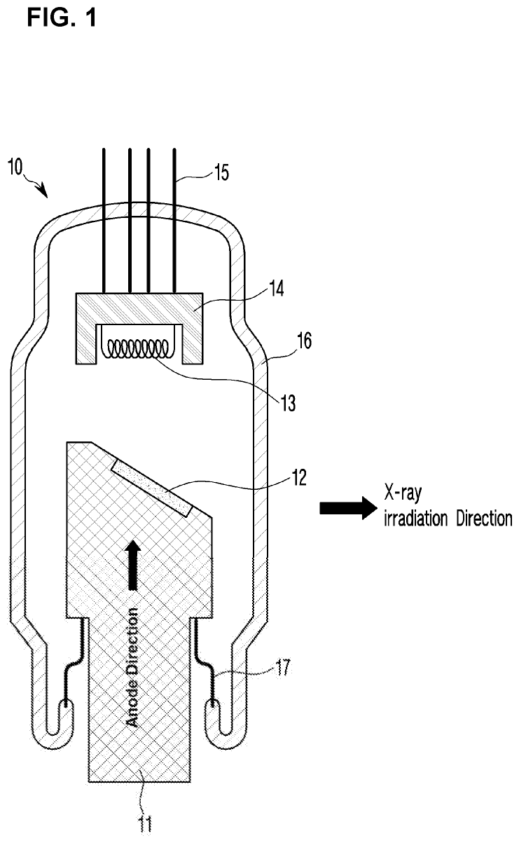

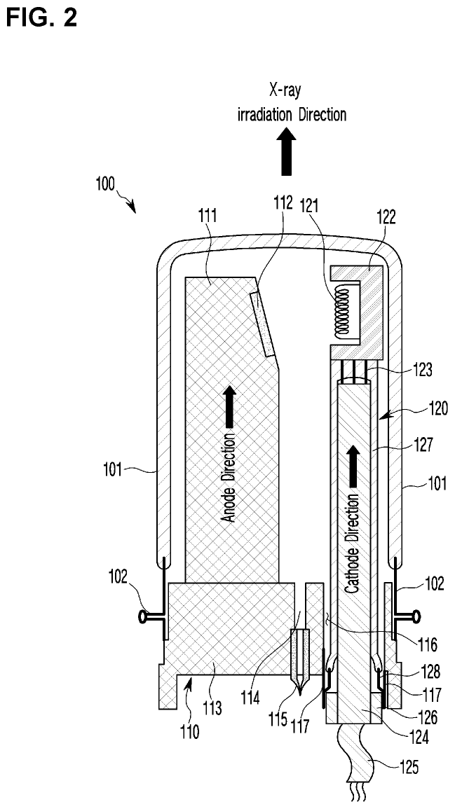

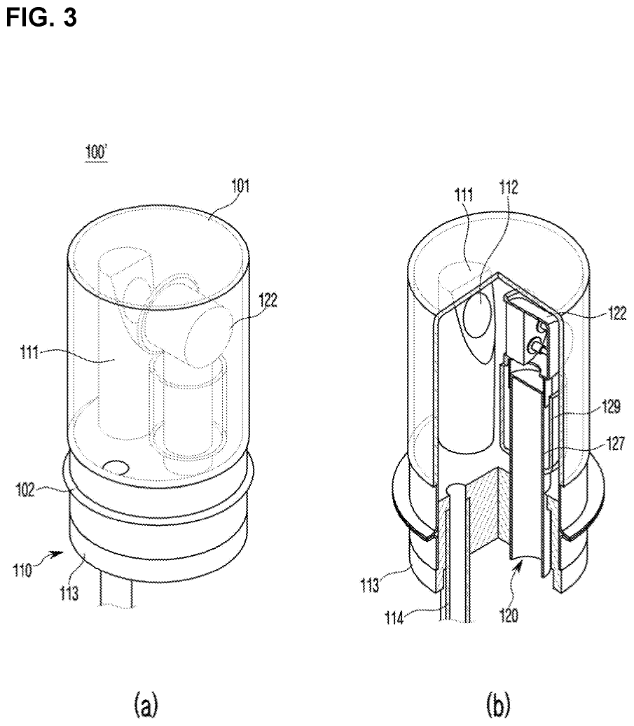

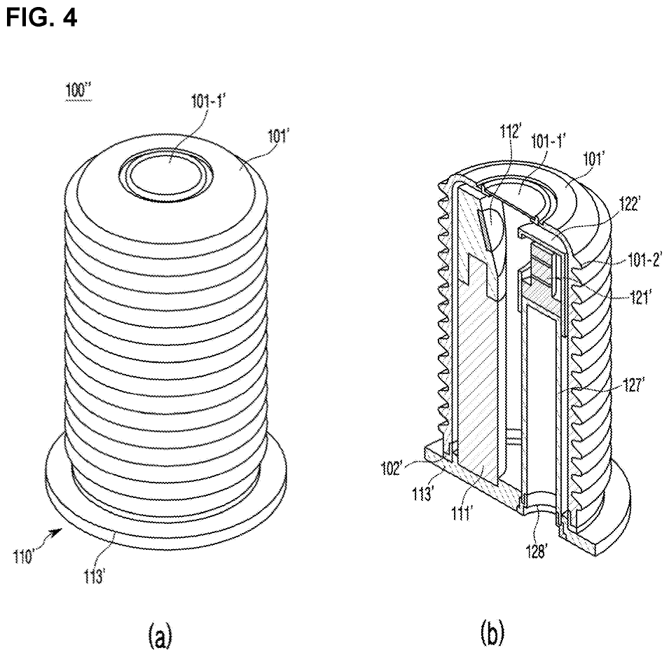

FIG. 1 is a structural diagram of a conventional X-ray tube, FIG. 2 is a structural diagram of an embodiment of an X-ray tube according to the present invention, FIG. 3 is a perspective view of another embodiment of an X-ray tube according to the present invention, and FIG. 4 is a perspective view of the third embodiment of an X-ray tube according to the present invention.

In order to utilize X-ray tube in terms of small size and light weight and simplify installation, disassembly, reassembly, folding, and unfolding etc. are necessary to increase mobility due to the characteristics of portable X-ray diagnostic equipment. In order to establish X-ray tube design technology with a special specification optimized for portable type and high output function, thermal distribution analysis of anode and anode shape and anode structure design are needed. In particular, filament shape and filament structural design and heat release characteristics should be set to calculate the electron beam trajectory for the design of the cathode focusing tube. If the cathode and anode of the X-ray tube are arranged in the same direction in parallel, and the size of the high voltage insulation structure and the X-ray leakage prevention shielding structure is reduced, the mono tank structure can be made by compact and lightweight.

In this regard, the portable X-ray tube 100 according to the present invention will be described in detail with reference to the drawings.

As shown in FIG. 2, the portable X-ray tube 100 according to the present invention comprises an anode portion 110, a cathode portion 120, and a vacuum bulb 101 covering the anode portion and the cathode portion to form a vacuum, kovar adapter 102 for fixing the vacuum bulb to the anode portion 110.

In detail, the anode portion 110 includes an anode heat sink 113, an anode 111 extending upwardly on the anode heat sink 113, and an inclined surface formed on an upper end of the anode 111, and an anode target 112 formed on the inclined surface. The anode 111 and the anode heat sink 113 are formed of oxygen free copper, and the anode target 112 is made of tungsten. The anode target 112 is formed on the inclined surface of the top of the anode, and the direction of the target is installed to face the cathode filament so that the heat electron beam irradiated from the cathode filament is reflected after the impact. The anode heat sink 113 stores and emits heat generated when the electron beam collides with the anode target. Therefore, in order to realize high power and high energy, the heat capacity of the anode heat sink 113 should be large. Since the anode heat sink 113 according to the present invention is formed separately from the anode and made by the figuration of a wide plate, the heat capacity is large, and thus high power and high energy can be realized. The anode heat sink 113 is impregnated in the insulating oil to release the stored heat. A vacuum exhaust hole 114 and an installation hole of the cathode portion 116 are formed in the anode heat sink 113. After the vacuum bulb 101 is mounted on the anode heat sink 113 using the kovar adapter 102, the vacuum exhaust hole 114 is required for vacuum exhaust. After the vacuum exhaust, the end of the vacuum exhaust tube 115 is sealed. The kovar adapter 102 attached to the anode heat sink 113 may be formed to wrinkle outward for heat dissipation.

The cathode portion 120 includes a cathode filament 121, a cathode focusing tube 122 on which the cathode filament 121 is mounted and focuses the hot electron beam irradiated from the cathode filament 121, and an electrode stem 123 for supplying power to the lower portion of the cathode focusing tube, and a high voltage insulation bushing 124 formed under the electrode stem 123 to insulate a high voltage while supplying power to the electrode stem 123, and a high voltage insulation bushing 124, and a power cable 125 inserted into the high voltage insulation bushing to be connected to the electrode stem 123, and a cathode support tube 127 formed to surround the electrode stem 123 at a lower portion of the cathode focusing tube 122, and a cathode kovar adapter 128 to fix the cathode support tube 127 to the high voltage insulation bushing 124 as expansion tube 126 is formed at the lower end of the insulation bushing. The cathode filament 121 has a structure in which a groove is formed in the cathode focusing tube 122 and is mounted in the groove. Therefore, by forming the groove, it can serve as a shield plate. The cathode kovar adapter 128 is attached to the anode kovar adapter 117 whose one side is attached to the anode heat sink 113. Accordingly, the cathode portion 120 is fixed to the anode heat sink 113. In addition, the cathode is insulated from the anode by the high voltage insulating bushing 124 and the cathode support tube 127. Therefore, high voltage can be supplied to high voltage insulating bushing 124.

The vacuum bulb 101 may be formed of glass or ceramic. In addition, the cathode support tube 127 may also be formed of glass or ceramic. The anode and the anode heat sink are preferably made of oxygen-free copper.

FIG. 3 is another embodiment of a portable X-ray tube 100′ according to the present invention. FIG. 3 is the same as the drawing of FIG. 2, but only a difference in that the cathode support tube 127 has expanded tube 129. Therefore detail description for another embodiment will be omitted.

FIG. 4 is the third embodiment of a portable X-ray tube 100″ according to the present invention. In FIG. 4, the vacuum bulb 101′ has a difference in that it is made of ceramic. As shown in the figure, the vacuum bulb 101′ may be formed in a corrugated shape 101-2′ for heat dissipation, and a beryllium (Be) window 101-1′ which X-rays can pass through the vacuum bulb 101′ made of ceramic. Other configurations are substantially the same as the embodiment of FIG. 2, and thus detailed descriptions will be omitted.

In order to meet the requirements of miniaturization and light weight, there is a limit of output, and in order to satisfy the requirement of output, there is a limit of weight. In order to set the target specification as superior to domestic and foreign products in output and resolution, the present invention has a voltage of 160 kV and a focus distance of 1.5 mm. In the present invention, in order to develop a special specification X-ray tube optimized for small size and high power function, the shape of the cathode focusing tube is modeled so that the focal size of the target focal plane is 1.5 mm in width and 5.5 mm in length in a new cathode and anode structure (target angle 16°, irradiation direction effective focus 1.5 mm×1.5 mm).

In addition, when a user operate a mobile device in close proximity or carry to operate a portable device, the user is exposed to X-ray exposure by scattering X-rays and self-leakage X-rays (50 mR/h or less allowable value), but in the X-ray tube according to the present invention, remote control can be performed by remote controller or mobile PC so that the user can avoid X-ray exposure.

As described above, the present invention can be variously modified and preferred embodiments of the present invention are described, but the present invention is not limited to these embodiments. It should be understood that techniques which can be modified and used by those skilled in the art in claims and the detailed description of the present invention are included in the scope of the present invention.

### INDUSTRIAL APPLICABILITY

The present invention relates to a portable X-ray tube and more particularly, to a portable X-ray tube capable of miniaturization and light weight by reducing the structural volume of the X-ray tube by installing the cathodes in the same direction together with the fixed anode

1. A portable X-ray tube comprising;
an anode portion comprising an anode heat sink for conducting and dissipating heat transferred through the anode, an anode formed on the upper part of the anode heat sink, and an anode target formed on the inclined surface of the upper end of the anode;
a cathode portion installed in parallel with the anode through the installation hole of the cathode portion formed in the anode heat sink; and
a vacuum bulb fixed to the heat sink to seal the anode portion and the cathode portion with a vacuum;
wherein the X-rays emitted through the anode target are irradiated to the upward direction as the installation direction of the anode.

2. The portable X-ray tube of claim 1,
wherein the vacuum bulb is fixed by kovar adapter which one side is coupled to the outer circumferential surface of the anode heat sink made of a cylindrical shape and the other side is coupled to the vacuum bulb.

3. The portable X-ray tube of claim 2,
wherein the kovar adapter is formed to wrinkle outward for heat dissipation.

4. The portable X-ray tube of claim 1,
wherein a vacuum exhaust hole for vacuum exhaust of the vacuum bulb is formed in the anode heat sink, and the vacuum exhaust tube is mounted in the vacuum exhaust hole to be sealed after vacuum exhaust.

5. The portable X-ray tube of claim 1,
wherein the cathode portion comprising:
a cathode filament facing the anode target to emit accelerated hot electrons to the anode target;
a cathode focusing tube mounted in a groove formed inside the cathode filament to focus an electron beam emitted from the cathode filament;
a cathode electrode stem connected to a lower portion of the cathode focusing tube;
a cathode high voltage insulation bushing connected to a lower portion of the cathode electrode system;
a power cable connected to a lower portion of the cathode high voltage insulation bushing; and
a cathode support tube surrounding the cathode electrode system and the cathode high voltage insulation bushing.

6. The portable X-ray tube of claim 5,
wherein the cathode support tube is penetrated through the installation hole of the cathode portion, and the lower end of the cathode support tube is fixed to the installation hole of the cathode portion by kovar adapter.

7. The portable X-ray tube of claim 6,
wherein the cathode support tube is made of glass or ceramic.

8. The portable X-ray tube of claim 1,
wherein the vacuum bulb is formed of glass or ceramic.

9. The portable X-ray tube of claim 8,
wherein a beryllium (Be) window is formed on an upper portion of the ceramic vacuum bulb.
